(19) United States
(12) Patent Application Publication
(10) Pub. No.: US 2006/0053405 A1
(43) Pub. Date: Mar. 9, 2006

(54) Integrated circuit design method

(75) Inventor: Bernardo De Oliveira Kastrup Pereira, Eindhoven (NL)

Correspondence Address: PHILIPS ELECTRONICS NORTH AMERICA CORPORATION;INTELLECTUAL PROPERTY & STANDARDS, 1109 MCKAY DRIVE, M/S-41SJ, SAN JOSE, CA, 95131, US

(73) Assignee: Koninklijke Philips Electronics N.V., Eindhoven (NL)

(21) Appl. No.: 10/515,151

(22) PCT Filed: Apr. 25, 2003
(86) PCT No.: PCT/IB03/01839

§ 371 Date: Nov. 19, 2004

(30) Foreign Application Priority Data
May 23, 2002 (EP) 020769956

(51) Int. Cl. G06F 17/50

(52) U.S. Cl. 716/18; 716/16; 716/17

(57) ABSTRACT

A design method for designing an integrated circuit (IC) and a corresponding integrated circuit design tool are presented. An IC design having a plurality of building blocks (121-129) being interconnected by a plurality of interconnection wires (131-139) is represented by a two-dimensional representation (200) mimicking the positions of the building blocks (121-129) and interconnections (131-139) in the actual IC lay-out. The two-dimensional representation allows the IC designer to evaluate the lengths of the interconnection wires (131-139), which enables the IC designer to alter the IC design before the IC design back-end, e.g. the IC area optimization, is entered, thus leading to a more effective IC design method.

The present invention relates to method for designing an integrated circuit, the method comprising a first step of selecting a plurality of building blocks for mapping a desired functionality onto an integrated circuit design; a second step of making a connection between a first and a second building block from the plurality of building blocks to enable communication between the first and the second building block; and a step of displaying an integrated circuit design resulting from the execution of the first step and the second step.

The ongoing downscaling of semiconductor dimensions has led and still leads to an increase of the number of building blocks being integrated on the available area of an integrated circuit (IC). This increases the required design effort for such an IC, not only because more functionality has to be added to the IC but, more importantly, because the increase of the number of integrated building blocks typically is associated with an increase of the interconnect density as well. The latter can introduce performance hazards in the IC design, because the presence of relatively long interconnects between building blocks in the IC design can have a detrimental effect on both signal propagation and power consumption. This is becoming increasingly problematic, because the increased building block density makes it more difficult to connect each building block to another building block via a relatively short interconnect. The impact of this design complication is amplified by the fact that in future IC technologies, e.g. deep submicron technologies, wire delay will become a dominant performance factor.

The design methods of the opening paragraph can be qualified as front-end design processes, e.g. processes in which the desired functional behavior of the IC is designed. In such front-end design processes, the functionality of the IC is specified by means of an algorithm specification in a design language like C⁺⁺. Subsequently, this specification serves as an input for a synthesis tool, which maps the required functionality on a hardware template by selecting the building blocks and interconnections between the building blocks that are necessary to implement the algorithm. An example of such a synthesis tool is provided by the electronic design automation (EDA) tool A/RT designer by Adelante technologies, as advertised on their webpage http://www.adelantetech.com, which is a tool particularly useful for the design of the data paths of very long instruction word (VLIW) architectures. After the tool has created such a template, it provides the designer with feedback by schematically depicting the template in an architectural view; the building blocks are placed in a single row and the interconnects are wrapped around the row of the building blocks. Although the actual length of the interconnects is not represented in the architectural view, this feedback allows the designer to manually define the building blocks and to assign operations to the resources and is therefore a useful feature in such a synthesis tool.

After the front-end design has been finalized, the back-end design process is entered, which is involved with the IC layout. This includes the minimization of silicon real estate and the reduction of the length of the present interconnections to optimize the data communication performance of the IC, for instance by means of floor-planning algorithms. However, the latter task is far from trivial and is becoming increasingly difficult with the increasing number of building blocks being integrated on the IC. In fact, it is likely that in the foreseeable future such time-consuming back-end optimization tasks cannot be optimally completed for a significant number of very large scale integration (VLSI) IC designs, simply because the optimization problem is becoming too complex. In such cases, the IC has to be redesigned in the front-end design process, which leads to a highly unwanted increase of the time-to-market of the IC.

Inter alia, it is an object of the present invention to provide an IC design method of the kind described in the opening paragraph that reduces the chance of the occurrence of unsolvable optimization problems in the design back-end.

Now, the object of the invention is realized in that the method further comprises a step of providing information about a length of the interconnection between the first and the second building block. The availability of such information provides the IC designer with important design characteristics of the IC design in the aforementioned architectural view of the design. If long interconnections between building blocks are present, the designer can conclude that it is likely that the back-end process will fail to provide an acceptable optimized IC design, and can decide to make other design choices based on the provided information on interconnect lengths, for instance in the architectural view of the synthesis tool. This is particularly useful in the field of VLIW IC design, because often trade-offs have to be made between the level of instruction-level parallelism, e.g. the number of building blocks being integrated in the design, and the complications like the presence of long block to block interconnects that are intrinsically connected to a high degree of parallellization in the IC design. For instance, if it is obvious for a designer that for a chosen algorithm implementation and the associated level of parallelism the presence of unacceptably long interconnect lines cannot be avoided, the designer can make the choice to reduce the level of parallelism, for instance by merging or eliminating building blocks, or decide to choose a different implementation of an algorithm, in order to remove the long interconnect from the design.

In an embodiment of the present invention, the step of providing interconnect information comprises providing the information in a form of a table listing an estimation of the length of the connection. In such a table, the designer can readily detect if unacceptably long interconnects are present in the design, and can choose to alter the design based on the information provided in the table.

In another embodiment of the present invention, the step of providing interconnect information comprises providing the information by displaying the integrated circuit design in a form of a two-dimensional representation including a display of a relative length of the interconnect connection. In such a representation, preferably in an architectural view of a synthesis tool, the designer is provided with a direct visualization of the preliminary layout, e.g. before back-end optimization has taken place, which can provide valuable information regarding the likelihood of failure of the back-end optimization.

It is an advantage if the method comprises a step of designer-controlled reallocation of the building block from a first position in the two-dimensional representation to a second position in the two-dimensional representation. Such functionality allows the designer to reallocate the building blocks having the undesired long connections with other building blocks, which provides redesign flexibility to the design method implemented by the design tool. For instance, a building block can be placed on top of another building block, which can be interpreted by the design method, e.g. the synthesis tool, as a design constraint for a next cycle in the IC design.

It is a further advantage if the step of designer-controlled reallocation is provided by means of a drag-and-drop algorithm. Such an algorithm, which is known per se, allows the designer to alter the design of the IC simply by dragging and dropping building blocks from one location to another, making the redesign of the IC very straightforward.

It is another advantage if the building block from the first position is interchanged in the two-dimensional representation with a building block from the second position. The swap of two building blocks ensures that all interconnections in the IC design remain present, and it enables a designer-driven optimization of the IC layout. The designer can play around with the ordering of the building blocks in an attempt to avoid or reduce the presence of too long interconnects in the IC design.

It is yet another advantage if the method comprises a step of introducing a design constraint for a next design cycle by designer-controlled selection of the interconnection between the building block and the further building block. The selection of an unwanted interconnection, either by manual, text-based input or by selecting an interconnection from a table or from a two-dimensional representation of the IC design, can be used to exclude the presence of such an interconnection in a synthesis redesign step, either by totally forbidding the presence of the interconnection or by restricting the interconnection to a maximum length.

Now, another object of the invention is realized by an integrated circuit design tool as claimed in claim 8. The integration of the design method of the present invention in a design tool enables an IC designer to avoid optimization problems in the back-end of the design process, which implies that the use of such a design tool will aid the designer in obtaining an acceptable IC design as quickly as possible. This is a large advantage, because time-to-market of an IC is becoming an increasingly critical parameter in the semiconductor market.

The invention is described in more detail and by way of non-limiting examples with reference to the accompanying drawings, wherein:

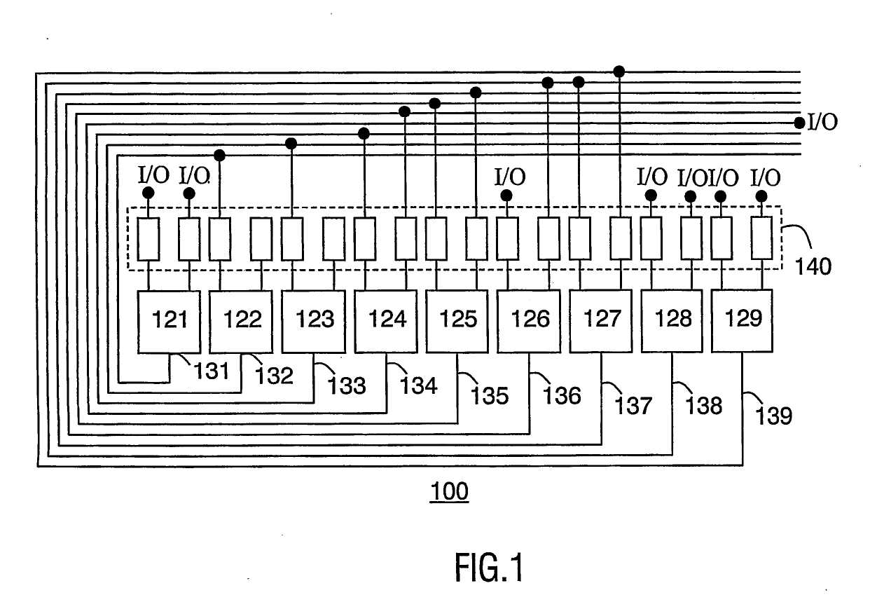

FIG. 1 depicts an architectural view of a prior art design method; and

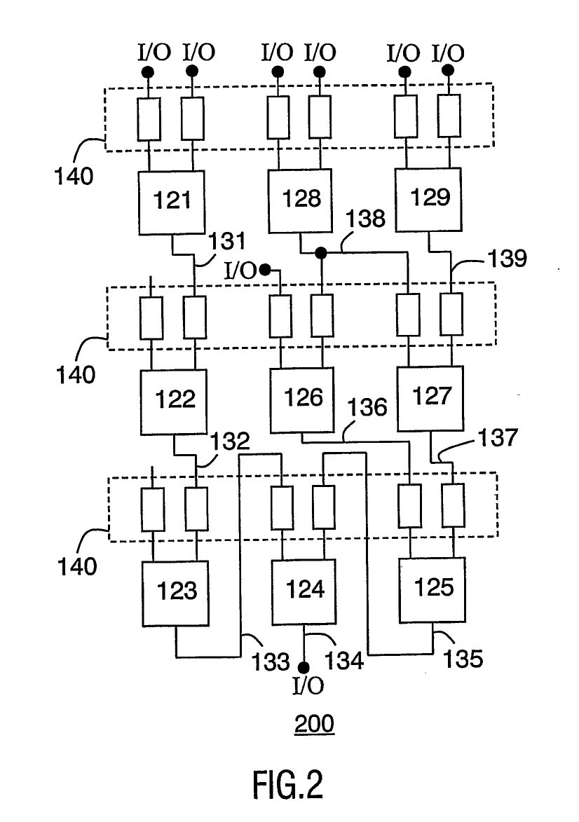

FIG. 2 depicts an architectural view of a design method according to the present invention.

FIG. 1 schematically shows the architectural view 100 of an IC design in A|RT designer, an IC design tool. Building blocks 121-129 are connected to interconnection wires 131-139 through their respective outputs. The interconnection wires 131-139 are wrapped around building blocks 121-129 and are fed back to an input of a building block from the building blocks 121-129 via a register from a distributed register file 140, or to an external connection, as indicated by the abbreviation I/O indicating an input/output connection. Obviously, the architectural view 100 provides useful information about the way building blocks 121-129 are interconnected through interconnection wires 131-139, but it provides no information whatsoever about the lengths of interconnection wires 131-139. Now, according to the present invention, this can be rectified by extending the architectural view 100 with a textual representation of an estimation of the lengths of interconnection wires 131-139 on IC lay-out level, for instance in the form of a pop-up or pull-down window, a table or another representation form. This will allow the designer to recognize potential performance hazards in the architectural view 100, which will enable the designer to alter the design accordingly, for instance by altering the algorithm implemented by building blocks 121-129 and their interconnect structure as realized by interconnection wires 131-139.

FIG. 2 is shown with backreference to FIG. 1. Corresponding reference numerals have the same meaning unless explicitly stated otherwise. In FIG. 2, a preferred embodiment of the present invention is depicted. The IC design as depicted in FIG. 1 is now represented in an architectural view 200 according to the present invention. In architectural view 200, the building blocks 121-129 and their interconnect wires 131-139 are displayed in a two-dimensional representation mimicking the location of the building blocks 121-129 and interconnection wires 131-139 in the actual IC lay-out. It is emphasized that it is not necessary that this representation exactly corresponds with the two-dimensional lay-out of the IC; as long as the two-dimensional representation of architectural view 200 approximates the actual lay-out, the view 200 provides the designer with useful information concerning the lengths of interconnection wires 131-139.

Consequently, the designer has the option to alter the IC design based on the information provided by architectural view 200. For instance, the architectural view 200 can be extended with functionality that allows the designer to move a building block from the building blocks 121-129 and move it from its first location to a second location, for instance by placing it on top of a second block from the building blocks 121-129. Preferably, this functionality is implemented by means of a drag-and-drop algorithm, although input-driven reallocation is feasible as well. The latter is especially feasible when the two-dimensional representation is extended with a coordinate system. The positions of these two building blocks might immediately be interchanged, but this is not a necessary requirement.

This way, the designer can play with the IC design as were it a jig-saw puzzle, swapping blocks around in an attempt to reduce the length of an interconnect wire from the interconnect wires 131-139. If the designer is unsuccessful in his attempts to reduce this length, the designer can decide to redesign the IC, either by introducing pipeline stages by merging blocks, by rewriting the algorithm specifying the IC functionality or by adding a constraint to the synthesis of the IC design, e.g. demand a maximum length for an interconnect wire between two building blocks or forbid the presence of an interconnect wire between those building blocks altogether. This constraint can be added either by text-driven input or by graphically selecting the interconnection in the architectural view 200 by representing the interconnection wires 131-139 in the architectural view as selectable, e.g. clickable, objects.

It is emphasized that the application of the present invention is especially advantageous in the field of VLIW processor datapath design, because in this area the designer typically encounters a large degree of flexibility in choosing a realization of the desired algorithmic functionality of the IC by varying the width of the data path, e.g. the amount of instruction-level parallelism, and by varying the building blocks in the data path. The present invention will aid the designer to choose a realization of the data path that is unlikely to cause lay-out problems in the IC design back-end, which will reduce the chance that in the design back-end the aforementioned lay-out problems will arise.

It should be noted that the above-mentioned embodiments illustrate rather than limit the invention, and that those skilled in the art will be able to design many alternative embodiments without departing from the scope of the appended claims. In the claims, any reference signs placed between parentheses shall not be construed as limiting the claim. The word “comprising” does not exclude the presence of elements or steps other than those listed in a claim. The word “a” or “an” preceding an element does not exclude the presence of a plurality of such elements. The invention can be implemented by means of hardware comprising several distinct elements, and by means of a suitably programmed computer. In the device claim enumerating several means, several of these means can be embodied by one and the same item of hardware. The mere fact that certain measures are recited in mutually different dependent claims does not indicate that a combination of these measures cannot be used to advantage.

1. A method for designing an integrated circuit, the method comprising:
a first step of selecting a plurality of building blocks for mapping a desired algorithmic functionality onto an integrated circuit design;
a second step of making a connection between a first and a second building block from the plurality of building blocks to enable communication between the first and the second building block; and
a step of displaying the integrated circuit design resulting from the execution of the first step and the second step,
characterized in that the method further comprises a step of providing interconnect information about a length of the interconnection between the first and the second building block.

2. A method as claimed in claim 1, characterized in that the step of providing interconnect information comprises providing the interconnect information in a form of a table listing an estimation of the length of the connection.

3. A method as claimed in claim 1, characterized in that the step of providing interconnect information comprises providing the information by displaying the integrated circuit design in a form of a two-dimensional representation including a display of a relative length of the interconnect connection.

4. A method as claimed in claim 3, characterized in that the method comprises a step of designer-controlled reallocation of the building block from a first position in the two-dimensional representation to a second position in the two-dimensional representation.

5. A method as claimed in claim 4, characterized in that the step of designer-controlled reallocation is enabled by means of a drag-and-drop algorithm.

6. A method as claim 4, characterized in that the building block from the first position is interchanged in the two-dimensional representation with a building block from the second position.

7. A method as claim 1, characterized in that the method comprises a step of introducing a design constraint for a next design cycle by designer-controlled selection of the interconnection between the building block and the further building block.

8. An integrated circuit design tool, the tool comprising:
first means for selecting a plurality of building blocks for mapping a desired algorithmic functionality onto an integrated circuit design;
second means for making a connection between a first and a second building block from the plurality of building blocks to enable communication between the first and the second building block; and
display means for displaying the integrated circuit design resulting from the first means and the second means,
characterized in that the design tool further comprises means for providing interconnect information about a length of the interconnection between the first and the second building block.
